(19) United States
(12) Patent Application Publication
(10) Pub. No.: US 2009/0163660 A1
(43) Pub. Date: Jun. 25, 2009

(54) ADHESIVE FOR APOLAR SUBSTRATES

(75) Inventors: Thorsten KRAWINKEL, Hamburg (DE); Christian Ring, Stelle (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 12/327,855

(22) Filed: Dec. 4, 2008

(30) Foreign Application Priority Data
Dec. 21, 2007 (DE) 10 2007 063 083.4

(51) Int. Cl. C08L 53/00

(52) U.S. Cl. 525/89

(57) ABSTRACT

A pressure-sensitive adhesive which develops a high bond strength to substrates of low surface energies, even at low temperatures. The adhesive is composed of a first block copolymer A-B and a second block copolymer which is composed of at least two and not more than eleven connected subunits A-B, A being in each case a polymer block comprising vinylaromatic monomer units and B being in each case a poly(1,3-diene). The first block copolymer is present in the adhesive in a fraction of at least 50% by weight, based on the total mass of the block copolymers in the adhesive. The adhesive additionally contains tackifier resins, of which at least 30% by weight are liquid at room temperature and which are miscible with the polymer blocks B, but not with the polymer blocks A. An adhesive tape with the pressure-sensitive adhesive is also described.

The invention relates to a pressure-sensitive adhesive comprising tackifier resins, a first block copolymer having the general structure A-B and a second block copolymer which is composed of at least two and not more than eleven connected subunits of the general structure A-B, A being in each case a polymer block which comprises monomer units from the group of vinyl compounds containing at least one aromatic group, and B being in each case a polymer block which comprises monomer units from the group of unsubstituted and substituted 1,3-dienes, the first block copolymer being present in a fraction of at least 50% by weight, based on the total mass of the block copolymers in the adhesive, and also to the use of a pressure-sensitive adhesive of this kind for producing a pressure-sensitive, substantially two-dimensional element. The invention further relates to the pressure-sensitive, substantially two-dimensional element with a pressure-sensitive adhesive of this kind, and also to its use for bonding to a surface which has a surface energy of less than 45 mJ/m².

One of the most important technologies for joining to workpieces is the adhesive bonding of the workpieces. In that case, through a skillful selection of the adhesives employed, success is achieved in joining a multiplicity of different materials with one another via adhesive bonds. The type of adhesive employed that allows easy joining of two workpieces is preferably the pressure-sensitive adhesive.

Pressure-sensitive adhesives (PSAs) are adhesives which permit permanent bonding to the substrate (the base) even under relatively weak applied pressure. The bondability of the adhesives is based on their adhesive properties.

“Adhesion” is typically the term for the physical effect which is responsible for the holding together of two phases, brought into contact with one another, at their interface by virtue of intermolecular interactions that occur at said interface. It is the adhesion, therefore, that determines the attachment of the adhesive to the substrate surface, and it can be determined in the form of tack and of bond strength. In order to exert a purposive influence over the adhesion of an adhesive, it is common to add plasticizers and/or bond strength enhancer resins (referred to as “tackifiers”) to the adhesive.

“Cohesion” is typically the term for the physical effect which results in the internal holding together of a compound or composition by virtue of intermolecular and/or intramolecular interactions. It is the cohesion forces, therefore, that determine the viscousness and fluidity of the adhesive, which can be determined, so to speak, as viscosity and as holding power. In order deliberately to increase the cohesion of an adhesive, it is often subjected to additional crosslinking, for which the adhesive is admixed with reactive (and therefore crosslinkable) constituents or other chemical crosslinkers and/or is exposed to ionizing radiation in an aftertreatment.

The technical properties of a PSA are determined primarily by the relation between adhesive and cohesive properties. For certain applications, for example, it is important that the adhesives used are highly cohesive, i.e. possess a particularly strong internal hold, whereas for other applications a particularly high adhesion is required.

It has proved to be difficult in practice to find suitable PSAs which have a high bond strength on low-energy surfaces. Low-energy surfaces for the purposes of this invention are all surfaces which consist of a material whose surface energy is less than 45 mJ/m², frequently, indeed, less than 40 mJ/m² or even than 35 mJ/m². Materials of this kind are also referred to as apolar materials. Typical substances with low-energy surfaces include low-density polyethylene (LDPE), high-density polyethylene (HDPE), polypropylene or copolymers of ethylene and propylene and also further olefins, an example being ethylene-propylene-diene rubber (EPDM).

Since polyethylene, polypropylene and ethylene-propylene-diene rubbers are materials often employed for films, and are also used, furthermore, in other forms, such as solid bodies or foams, for example, there is a great need for adhesives for the bonding of apolar materials of this kind.

The majority of PSAs available on the market can be utilized only to a limited extent for such low-energy surfaces, since these adhesives are unable to develop sufficient bond strength to such surfaces. In order to adapt a conventional PSA for bonding to apolar substrates, it is typically admixed with auxiliaries which cause the adhesive overall to become softer, examples being tackifier resins or plasticizers. Although this does result in an increase in the adhesion to low-energy surfaces, it is accompanied by a decrease in viscosity and hence, overall, by a reduction in cohesion; consequently, overall, it is not possible to produce a bond which is mechanically robust.

As well as the selection of a PSA with a view to the nature of the surface to which bonding is to take place, the ambient conditions under which an adhesive bond is to be ensured are likewise important. Thus it is problematic, for instance, to find PSAs which exhibit a high bond strength on the corresponding substrate at low temperatures but also, at the same time, afford sufficiently high bond strength at room temperature or even higher temperatures as well. This problem occurs, for instance, in the case of adhesive bonds which are used to seal containers for frozen goods, such as freezer bags, for example.

The pressure-sensitive adhesive characteristics of an adhesive are dependent, among other factors, on the glass transition temperature, T_{g}, of the adhesive, since at temperatures below the glass transition temperature these adhesives harden and thus lose both their tack and their bond strength. The temperatures reported below correspond to those obtained in quasi-steady-state experiments, such as by means of dynamic scanning calorimetry (DSC).

There are certain PSA systems known which are able to develop a high bond strength to apolar substrates. Furthermore, numerous trials have been undertaken at altering the bonding characteristics of such PSAs, by means of specific additization, in such a way that they have a high bonding strength at low temperatures as well.

Thus, for example, adhesives based on styrene block copolymers are known which develop a higher bond strength on low-energy surfaces than is the case with other PSAs, such as those based on acrylates or natural rubbers, for instance. To increase the bond strength of such styrene block copolymer adhesives further, on apolar substrates, they may additionally be admixed with various additives and tackifier resins.

U.S. Pat. No. 5,453,319, for example, discloses pressure-sensitive adhesives which comprise a diblock copolymer (i.e. a block copolymer comprising two different homopolymer blocks; this is also referred to as a two-block copolymer) of the general type A-B, and a multiblock copolymer which is composed of subunits of the general type A-B, and also, furthermore, a solid tackifier resin and a liquid tackifier resin (20% by weight) with aliphatic and aromatic constituents. Polymer block A here contains aromatic hydrocarbons having a monoalkenyl group, and polymer block B here contains 1,3-butadiene. It is certainly possible with this system to obtain glass transition temperatures of down to −12° C.; however, such systems have always exhibited a significantly poor shear strength, since the cohesion of such systems was insufficient to allow a stable adhesive bond even at low temperatures. Furthermore, the samples described in U.S. Pat. No. 5,453,319 do not allow comparison with conventional products, since the layers of adhesive in these samples have very high thicknesses in each case, and the bond strength of an adhesive increases in line with the thickness of its layer.

Furthermore, EP 1 151 052 discloses pressure-sensitive adhesives which likewise comprise a diblock copolymer of the general type A-B and a multiblock copolymer comprising subunits of the general type A-B (with polymer blocks A comprising aromatic hydrocarbons having an alkenyl group and with polymer blocks B comprising 1,3-butadiene) and also, furthermore, a polyphenylene oxide resin and a tackifier resin. When this adhesive was used, an increase in the bond strength on apolar substrates was indeed found, but its usefulness at low temperatures was not improved. Overall it is known that, with a high fraction of diblock copolymers in the PSA, its bond strength can be improved but its cohesion is considerably impaired at the same time.

It was an object of the present invention, therefore, to provide a pressure-sensitive adhesive which eliminates these disadvantages, being adapted in particular to develop a high bond strength for low-energy surfaces, and which is therefore formed on the basis of block copolymers having a high diblock copolymer content, and comprises a large fraction of liquid tackifier resins, but at the same time can also be used for adhesive bonds at low temperatures, without detriment to the cohesion of the adhesive.

This object is achieved in accordance with the invention by means of a pressure-sensitive adhesive of the type specified at the outset, in which at least 30% by weight of the tackifier resins are liquid at room temperature, based on the total mass of the tackifier resins, the tackifier resins that are liquid at room temperature being tackifier resins which are not homogeneously miscible with the polymer blocks A and also are substantially homogeneously miscible with the polymer blocks B. In accordance with the invention, therefore, a tackifier resin is used which has relatively firm constituents and has relatively soft constituents, the latter interacting with the elastomer blocks of type B.

As a result of this embodiment it is ensured that the PSA of the invention contains a large fraction of liquid resins. In view of the high fraction of resins that are liquid at room temperature, of more than 30% by weight, adhesives of this kind are very soft even at relatively low temperatures, and thus possess a high tack.

The tackifier resins are selected such that they are not miscible with the polymer blocks of type A—that is, with the blocks having monomer units comprising vinyl compounds containing at least one aromatic group. Since these polymer blocks constitute the fraction of the block copolymer that, within the polymer blocks, has a high strength and is therefore relatively hard (the so-called hard blocks or hard segments), which as a result substantially codetermines the cohesive properties of the polymer, the bond strength of the hard blocks at a microscopic level is not altered by the addition of the tackifier resins, these polymer blocks making only a small contribution to the adhesion. Since the hard blocks are not miscible with the liquid tackifier resins, the hard blocks may be considered, so to speak, to be a filler in relation to the liquid tackifier resins. Hard blocks of this kind typically have glass transition temperatures of more than 90° C.

In contrast, the tackifier resins must be substantially homogeneously miscible with the polymer blocks of type B—that is, with the blocks having monomer units which comprise substituted and unsubstituted 1,3-dienes. These polymer blocks constitute the fraction of the block copolymer which is soft (the so-called soft blocks or soft segments). As a result of the addition of the tackifier resins, these regions become even softer, at a microscopic level, without an accompanying reduction in the shear strength of the adhesive overall. Tackifier resins of this kind are well known in large numbers to the skilled person.

With this specific composition, the adhesives of the invention differ significantly from the prior-art PSA mixtures and therefore allow mechanically stable adhesive bonds on apolar substrates even at low temperatures. This is not allowed, for instance, by the tackifier resins described in U.S. Pat. No. 5,453,319, since on account of their aromatic properties they exhibit good miscibility with the polymer blocks of vinylaromatics (type A) and not with the polymer blocks of dienes (type B), and so the cohesion of this adhesive is inadequate overall.

The tackifier resins that are liquid at room temperature may be aliphatic tackifier resins. Through the choice of such tackifier resins it is possible to ensure in a particularly simple way that they are readily miscible with the polymer blocks of type B and are not homogeneously miscible with the polymer blocks of type A. In terms of miscibility and compatibility with the polymer blocks of type B, therefore, the liquid tackifier resins obtained therein are outstandingly suitable and, equally, allow the preparation of PSAs having an outstanding mechanical stability even at relatively low temperatures.

In particular it has proved to be advantageous if the tackifier resins comprise polyterpene resins, preferably those based on limonenes and/or pinenes, more particularly alpha-pinene. At room temperature, these tackifier resins are typically in solid form and an ideal supplement to the tackifier resins that are liquid at room temperature, ensuring overall a high bond strength on apolar substrates.

It is favorable, furthermore, if the pressure-sensitive adhesive is adjusted for a glass transition temperature of less than −15° C., preferably of less than −20° C. Specific measures to adapt the glass transition temperature are well known to the skilled person—for instance, via the choice of the particular monomer units used, using the equation compiled by Flory and Fox, as described below. A low glass transition temperature of this kind allows mechanically robust bonds to be producible even at low temperatures of down to −20° C. by use of the adhesive of the invention.

It has emerged as being advantageous if the polymer block used for type A is in each case a polymer block which comprises monomer units from the group of unsubstituted and/or substituted styrenes. The choice of such subunits for the base polymer of the PSA ensures a particularly high bond strength on low-energy surfaces. Especially advantageous results can be achieved through the use of a particularly high level of styrene in the block copolymer, specifically when the first block copolymer and/or the second block copolymer includes a fraction of at least 20% by weight of monomer units from the group of unsubstituted and/or substituted styrenes.

Moreover, as the polymer block of type B, it is possible to select in each case a polymer block which comprises monomer units from the group of unsubstituted and/or substituted 1,3-butadienes and/or isoprenes. A constitution of this kind makes it possible to realize adhesives having a particularly high internal cohesion. This is especially important if, in addition, polymer blocks with styrenes as monomer units are used as polymer blocks of type A in order overall to ensure a high level of mechanical robustness of the bond on low-energy surfaces. It may additionally be of advantage for the subunits in the second block copolymer to be connected to one another linearly or in star format. In this case block copolymers are obtained which by virtue of their three-dimensional arrangement enter into strong intermolecular interactions with other polymer molecules and hence ensure particularly high cohesion even at low temperatures.

Finally it is advantageous if the first block copolymer and the second block copolymer are present together in a fraction of at least 20% by weight and not more than 70% by weight, preferably in a fraction of at least 30% by weight and not more than 60% by weight, more particularly in a fraction of at least 35% by weight and not more than 55% by weight, based in each case on the total mass of the adhesive. Through the use of such a block copolymer content (corresponding to the sum of the fraction of the first block copolymer and the fraction of the second block copolymer) a fundamentally high bond strength for the adhesive is ensured.

It was a further object of the present invention to provide a pressure-sensitively adhesive, substantially two-dimensional element which allows a mechanically robust bond even at low temperatures on low-energy surfaces. This object has been achieved through the use of the above-described PSA for producing a pressure-sensitively adhesive, substantially two-dimensional element, and also by the pressure-sensitively adhesive, substantially two-dimensional element thus obtained. As a result of the use of this pressure-sensitively adhesive, substantially two-dimensional element for bonding with a surface which has a surface energy of less than 45 mJ/m², moreover, it has been possible to obtain particularly robust bonds on such substrates, even at low temperatures.

The invention relates to the composition of the pressure-sensitive adhesive (PSA). PSAs are adhesives which allow a permanent bond to the substrate even at relatively weak applied pressure. The bondability of the adhesives is based on their adhesive properties.

An adhesive of this kind typically comprises as its main constituent a base polymer or a mixture of two or more base polymers. These polymers may be modified in respect of the particular profile of requirements desired, by means of additions of further auxiliaries, which may also, furthermore, be polymeric in nature.

The present PSA comprises at least two copolymers as base polymers, namely a first block copolymer and a second block copolymer. Copolymers are polymers which are composed of at least two different types of monomer units. Block copolymers are copolymers which have at least two different polymer blocks as structural units. In accordance with the number of (different) blocks they contain, block copolymers are classed, for instance, as diblock copolymers (having two polymer blocks), triblock copolymers (having three polymer blocks) or multi-block copolymers (having a multiplicity of polymer blocks).

Polymer blocks are oligomers or polymers (homopolymers) which as their main structural unit have a single kind of monomer units, of which a multiplicity are connected substantially sequentially to one another. For the targeted control of the physical and chemical properties of such polymer blocks, they may also, furthermore, contain individual monomer units which are different in construction from the main structural units.

The adhesive of the invention has as an elastomeric component a first block copolymer and a second block copolymer; these two—together where appropriate with further constituents of the adhesive based on block copolymers—contribute, accordingly, to the total mass of the block copolymers of the adhesive.

The first block copolymer is present in the adhesive in a fraction of at least 50% by weight, based on the total mass of the block copolymers; the first block copolymer hence forms the polymeric main constituent of the adhesive.

The first block copolymer is a diblock copolymer, i.e. a polymer composed of two different polymer blocks, one polymer block of type A and one polymer block of type B. Since the polymer blocks of type A and of type B are joined to one another in the first block copolymer, the general structure of the first block copolymer is A-B.

A polymer block of type A comprises interconnected monomer units from the group of vinyl compounds containing at least one aromatic group. In addition to these monomer units there may also be further individual monomer units present in the polymer block of type A.

Vinyl compounds containing at least one aromatic group are those compounds which contain an unsubstituted vinyl group H₃C═CH—, or a singly or multiply substituted vinyl group which is derived from said group, which is joined to at least one organic group which has aromatic properties. A vinyl compound of this kind containing at least one aromatic group (also referred to as a vinylaromatic) is, fundamentally, any compound which falls within this class of substance; in the simplest case, the compound is unsubstituted styrene or comprises substituted styrenes. Monomers of this kind are present in polymerized form in the polymer block of type A. The polymer block of type A also includes polymer blocks which have only one single kind of monomers of the vinyl compounds containing at least one aromatic group, and also polymer blocks which have two or more different kinds of monomers of the vinyl compounds containing at least one aromatic group. The specification of a polymer block as belonging to type A, therefore, is not a statement either of the number of monomers that are present in this polymer block or of whether the monomer units of one polymer block of type A are identical to or different from other polymer blocks of this type within the same block copolymer or within a different block copolymer.

A polymer block of type B comprises interconnected monomer units from the group of unsubstituted and substituted 1,3-dienes. Suitable such unsubstituted and substituted 1,3-dienes are in principle all organic compounds which have two double bonds in 1,3 position; in the simplest case the compound in question is unsubstituted and/or substituted 1,3-butadiene and/or isoprene. Monomers of this kind are present in polymerized form in the polymer block of type B. The polymer block of type B also includes polymer blocks which have only one single kind of monomers from the group of unsubstituted and substituted 1,3-dienes, and also polymer blocks which have two or more different kinds of monomers from this group, i.e., for example, copolymers of butadiene and isoprene. The specification of a polymer block as belonging to type B, therefore, is not a statement either of the number of monomers that are present in this polymer block or of whether the monomer units of one polymer block of type B are identical to or different from other polymer blocks of this type within the same block copolymer or within a different block copolymer.

The second block copolymer is a multiblock copolymer, i.e. a polymer composed of two or more different polymer blocks, the structural units of this multiblock copolymer being composed of polymer blocks of type A and polymer blocks of type B. The second block copolymer is composed of subunits which are each composed of a polymer block of type A and a polymer block of type B, and so the subunits likewise possess the general structure A-B.

The polymer blocks of type A and the polymer blocks of type B are selected from the groups of compounds described for the first block copolymer. Within one adhesive it is possible for the polymer blocks of type A selected in the first block copolymer and the polymer blocks of type A selected in the second block copolymer to be identical in each case or else different. It is also possible in accordance with the invention, within one adhesive, to select the polymer blocks of type B that are used in the first block polymer, and the polymer blocks of type B that are used in the second block copolymer to be identical in each case or different.

In the second block copolymer of the PSA of the invention, in each case at least two and not more than eleven of these A-B subunits are joined to one another. As a result of this joining, the second block copolymer may have different structures; for example, the subunits may be linked to one another linearly. In the case of a linear linkage of this kind, the products are always partially alternating block copolymers of the general type (A-B)ₙ with 2≦n≦11, it being possible for the length of the polymer blocks of type A or of type B within one block copolymer to be different. This can be attributed to the fact that, in the case of a link of two subunits, in which two polymer blocks of an identical type are linked to one another, these two each correspond to a larger polymer block which likewise has that type. Thus, for example, in the case of the linking of two A-B′ subunits via the polymer blocks of type B, a block copolymer of type A-B′-B′-A would be obtained, which is equivalent to the description as block copolymer of type A-B″-A, the larger polymer block, of type B″, corresponding to the two smaller polymer blocks B′-B′ joined to one another (in this case B′ and B″ each belong to the general type B). This can be attributed to the fact that a joining of two identical polymer blocks of type A or of type B is in each case itself, again, a larger polymer block of type A or of type B, respectively. In this context it has proved all in all to be advantageous if the terminal polymer blocks of the second block copolymer are formed by relatively hard polymer blocks, in the present case, therefore, by polymer blocks of type A. (For this case, in view of the homogeneous miscibility of the tackifier resins that are liquid at room temperature, therefore, the compatibility with the middle block is particularly advantageous).

Accordingly the second block copolymer for the purposes of this invention is in the simplest case, then, a linking of two A-B subunits; this can be described as a tetrablock copolymer having the general structure A-B-A-B or as a triblock copolymer having the general structure A-B-A.

Furthermore, the A-B subunits in the second block copolymer may also be joined in star format, giving a radial block copolymer. The central linkage point may be, for instance, an additional linking unit, which either is part of the polymer blocks or is used separately.

Irrespective of the two examples emphasized here as being particularly advantageous, however, the A-B subunits in the second block copolymer may in principle be present in any arrangement, thus including, for instance, branched linkages of A-B subunits.

A mixture of block copolymers is therefore obtained, as the base polymer of the adhesive, said mixture being composed to an extent of at least 50% by weight of a diblock copolymer. In this context it is also possible to employ mixtures of different block copolymers and also partially or fully hydrogenated products. The diblock copolymer determines the softness of the adhesive overall and hence its bond strength, whereas the multiblock copolymer contributes essentially to its cohesion.

Taking account of this restriction, mainly that the greatest fraction of all of the block copolymers present in the adhesive is formed from the first block copolymer, it is possible, additionally, to specify the fractions of the first block copolymer and of the second block copolymer in the adhesive in such a way that the total fraction of the first block copolymer and of the second block copolymer in the adhesive is at least 20% and not more than 70% by weight, preferably at least 30% and not more than 60% by weight or even at least 35% and not more than 55% by weight, based in each case on the total mass of the adhesive.

Where unsubstituted and/or substituted styrenes are used as vinyl compounds containing at least one aromatic group, it is possible, moreover, for the fraction of the styrenic monomer units in the first block copolymer and/or in the second block copolymer to be chosen to be at least 20% by weight of the respective block copolymer, in order to ensure good cohesion of the adhesive overall.

The block copolymers of the adhesive of the invention can be prepared in principle via all processes for preparing block copolymers that are suitable and known for that purpose.

For the targeted control of the adhesive properties, the adhesive further comprises tackifier resins. Such tackifier resins are typically admixed to the base polymers in order to achieve an overall increase in the bond strength of the adhesive: that is, to make the adhesive more tacky.

As tackifier resins it is possible without exception to use all of the tackifier resins that are known and are described in the literature. They typically comprise mixtures of different kinds of tackifier resins, although a tackifier resin may also consist of a single kind of tackifier resin.

As tackifier resins it is possible in principle to use all suitable tackifier resins, such as unhydrogenated, partially hydrogenated or fully hydrogenated resins based on rosin or its derivatives, hydrogenated polymers of dicyclopentadiene, unhydrogenated, partially hydrogenated, selectively hydrogenated or fully hydrogenated hydrocarbon resins based on C₅, C₅/C₉ or C₉ monomer streams, polyterpene resins based on limonenes such as δ-limonene and/or on pinenes such as α-pinene (alpha-pinene) and β-pinene, and also mixtures thereof. Among these it is possible, for example, for alpha-pinene to be employed. Advantageously at least one of these tackifier resins has a softening point of at least 100° C. (determined by the ring & ball method), and hence is solid at room temperature.

In order to realize the invention, however, it is important, with regard to the selection of a tackifier resin, that at least 30% by weight of the tackifier resins used overall are formed by a tackifier resin or by two or more tackifier resins that is or are present in liquid form at room temperature.

Furthermore, the at least one tackifier resin liquid at room temperature must not be homogeneously miscible with the polymer blocks of type A, but instead must be so miscible with the polymer blocks of type B. Therefore, accordingly, it is necessary to ensure the fundamentally poorer miscibility of the liquid tackifier resin with vinylaromatic polymer blocks than with aliphatic polymer blocks.

Two components are considered homogeneously miscible (compatible) if, in the proportion in question, they can be mixed completely with one another in a homogeneous and continuous phase without any phase separation being observed, whether in the form of demixing or in the form of a disperse system, an emulsion or suspension for instance. As a result of this particular embodiment of the liquid tackifier resin, therefore, the tackifier resin is particularly compatible with the elastomer blocks of the block copolymers and is therefore disposed within the PSA in the case of the polymer blocks of type B, thus having the overall result of producing good bondability on the part of the adhesive at low temperatures.

Further to the tackifier resins, the PSA may comprise further formulating ingredients, which are intended, for instance, to tailor or adapt the properties of the adhesive. These may be all suitable additives and auxiliaries, examples being primary antioxidants such as sterically hindered phenols, for example, secondary antioxidants such as phosphites or thioethers, for example, in-process stabilizers such as C radical scavengers, for example, light stabilizers such as UV absorbers and sterically hindered amines, for example, processing assistants or end block reinforcer resins. Where appropriate it is also possible for further polymers to be provided as additives, preferably polymers which are elastomeric in nature, examples being those based on pure hydrocarbons, such as unsaturated polydienes, natural or synthetic polyisoprene or polybutadiene, for instance, substantially saturated elastomers such as saturated ethylene-propylene copolymers, a-olefin copolymers, polyisobutylene, butyl rubber, ethylene-propylene rubber, for instance, and chemically functionalized hydrocarbons such as halogen-containing, acrylate-containing or vinyl ether-containing polyolefins, for instance, without wishing to impose any restriction as a result of this exemplary listing.

It is also possible, furthermore, for the polymeric constituents of the adhesive to be adapted in a targeted manner for use at low temperatures, by, for instance, selecting the block copolymers such that the resulting adhesive has a glass transition temperature of less than −15° C., preferably of less than −20° C.

To achieve a glass transition temperature T_{g} of less than −15° C. for the adhesive it is possible, for instance, for the individual constituents of the adhesive to be selected, in terms of their structure and proportion in the adhesive, such that the desired value of the glass transition temperature T_{g} is given for the whole adhesive by equation (E1), in analogy to the equation presented by Flory and Fox, as follows:

$$\frac{{\sum }^{ } {w}_{i}}{{T}_{g}} = {\sum }_{i}^{ } \frac{{w}_{i}}{{T}_{g , i}} \qquad ( E 1 )$$

In this equation, i is the serial number of the adhesive constituents employed, wᵢ is the mass fraction of the respective constituent i (in % by weight) and T_{g,i} is the respective glass transition temperature of the constituent i (in K).

In this context it should be borne in mind that block copolymers composed of two polymer blocks, such as the first block copolymer or the second block copolymer, possess two glass transition temperatures: that of the polymer blocks of type A (the hard blocks) and that of the polymer blocks of type B (the soft blocks). The sole factor critical for the calculation of the glass transition temperature of the block copolymer as a whole is in the present case the glass transition temperature of the polymer blocks of type B, since the tackifier resins employed are compatible only with these polymer blocks. Therefore, when determining the respective mass fractions of the block copolymers, only those of the polymer blocks of type B should be taken into account.

The constituents of the adhesive of the invention can be mixed by all known methods that are suitable for such mixtures, such as in solution, in a dispersion, or as a melt—in an extruder, for example—or in a mixing assembly, such as a kneading device. The adhesives may be produced continuously, semi-continuously or discontinuously, as part of a batch process, for example. For the purpose of application, the blended PSAs may be applied to a temporary carrier (referred to as an in-process liner) or to a permanent carrier.

The adhesive of the invention can be used to produce a pressure-sensitively adhesive, substantially two-dimensional element (2D element for short). A 2D element for the purposes of this specification is any typical, suitable structure having a substantially two-dimensional extent. The 2D elements of the invention permit adhesive bonding and may take different forms, especially flexible forms, as an adhesive sheet, adhesive tape, adhesive label or shaped diecut. Pressure-sensitively adhesive 2D elements are 2D elements which can be bonded even under gentle applied pressure. For this purpose, the 2D element is equipped on one or both sides with at least one adhesive, and in the case of the double-sidedly bondable 2D element the adhesives on the different sides of the 2D element may be identical or different.

A 2D element of this kind may have a carrier or else may be of carrier-free design. Typically a carrier such as, for instance, films, wovens, nonwovens, foams or the like is used if the 2D element is to have a high mechanical robustness. The carrier-free design of a 2D element, in contrast, is of advantage in instances when, for instance, the aim is to realize adhesive bonds having a level of bonding which is low as far as possible.

To produce such a 2D element it is likewise possible to employ all of the typical process technologies; thus, for example, it is possible to process the PSA of the invention from solution, from dispersion or from the melt. Generally speaking, the aim is for production and processing methods in which the processing takes place from the solution or from the melt, the latter being particularly preferred. Here as well it is possible to select a continuous, semi-continuous or discontinuous operating regime; besides batch processes, it is common, for such manufacturing steps, to employ continuous processes using an extruder.

When the adhesives of the invention are used, pressure-sensitively adhesive 2D elements can be manufactured which even with low ambient temperatures are outstandingly suitable for bonding to apolar substrates, in other words to surfaces having a surface energy of less than 45 mJ/m². Thus, for example, it is possible to produce pressure-sensitively adhesive 2D elements which exhibit high bond strength to a high-density polyethylene (HDPE), of at least 8 N/cm, even at low temperatures.

Further advantages and possibilities for application will emerge from the working examples, which the text below is intended to describe in more detail.

In order to illustrate the general idea of the invention, five different PSAs were prepared exemplarily, and also two further PSAs as comparative examples (the latter contained a component which is liquid at room temperature but cannot be used as a tackifier resin). For this purpose the individual components of the PSAs were dissolved in toluene, the solids content of the resultant solution being adjusted to 40% by weight.

The solution thus obtained was applied, using a coating bar, to one side of a polyester film (polyethylene terephthalate with a thickness of 36 μm) and in subsequent drying step at 100° C. the toluene was removed. The coatweight achieved was in each case 50 g/m².

As the first block copolymer and as the second block copolymer the following commercially available block copolymers were employed:
Quintac 3433: styrene-isoprene-styrene copolymer (SIS) from Nippon Zeon with a diblock copolymer (first block copolymer) fraction of about 56% by weight and an overall polystyrene polymer block (type A) fraction of about 16% by weight;
Kraton D 1118: styrene-butadiene-styrene block copolymer (SBS) from Kraton Polymers with a diblock copolymer (first block copolymer) fraction of about 76% by weight and an overall polystyrene polymer block (type A) fraction of about 31% by weight;
Kraton D 1102: styrene-butadiene-styrene block copolymer from Kraton Polymers with a diblock copolymer (first block copolymer) fraction of about 14% by weight and an overall polystyrene polymer block (type A) fraction of about 30% by weight; and
Solprene 1205: styrene-butadiene block copolymer (SB) from Housmex with a diblock copolymer (first block copolymer) fraction of about 100% by weight and a polystyrene polymer block (type A) fraction of about 18% by weight.

Tackifier resins used were in each case mixtures of two commercially available tackifier resins, of which one was liquid at room temperature. The tackifier resin solid at room temperature used was as follows:
Pentalyn H-E: hydrogenated rosin ester from Eastman with a softening point of about 110° C. (Ring & Ball) and a glass transition temperature of 48° C.;
Dercolyte A 115: alpha-pinene resin from DRT with a softening temperature of about 115° C. and a glass transition temperature of 74° C.; and
Piccolyte A 135: alpha-pinene resin from Hercules with a softening temperature of about 135° C. and a glass transition temperature of 89° C.

Tackifier resins liquid at room temperature used were as follows:
Picco A 10: liquid hydrocarbon resin from Eastman with a glass transition temperature of −48° C.;
Foralyn 5020: liquid rosin resin from Eastman with a glass transition temperature of −31° C.; and
Wingtack 10: liquid hydrocarbon resin from Goodyear with a glass transition temperature of −31° C.

The component which is liquid at room temperature but does not serve as a tackifier resin, used for the comparative examples, was a naphthenic oil having a glass transition temperature of −64° C. (Shellflex 371 from Shell).

The five inventive adhesives E1, E2, E3, E4 and E5 and also the two Comparative Examples C1 and C2 had the compositions shown in Table 1 (stated in % by weight).

TABLE 1

| | E1 | E2 | E3 | E4 | E5 | C1 | C2 |
|---|---|---|---|---|---|---|---|
| Quintac 3433 | 45 | | | | | | |
| Kraton D 1118 | | 45 | 50 | | 30 | 20 | 22.5 |
| Kraton D 1102 | | | | 25 | 10 | | |
| Solprene 1205 | | | | 25 | | 20 | 22.5 |
| Pentalyn H- | 35 | 35 | | | | | |
| Dercolyte A115 | | | 30 | 30 | 35 | | |
| Piccolyte A135 | | | | | | 50 | 46 |
| Picco A 10 | 20 | | | | | | |
| Foralyn 5020 | | 20 | | | | | |
| Wingtack 10 | | | 20 | 20 | 25 | | |
| Shellflex 371 | | | | | | 10 | 9 |

The adhesives selected as comparative examples were PSAs based on block copolymers which in each case have a large fraction of tackifier resins and also, in addition, a liquid oil which itself, however, does not have pressure-sensitive adhesive properties.

Prior to the application of these adhesives, they are each admixed with one half mass fraction of an ageing inhibitor (sterically hindered phenol; Irganox 1010 from Ciba Additive) and of a UV protectant (Tinuvin P from Ciba Additive).

The single-sidedly pressure-sensitive adhesive 2D elements thus obtained were investigated for their technical adhesive properties, specifically for the bond strength, initial tack and holding power.

The bond strength was determined as follows: as a defined substrate, a steel surface and also a polyethylene (PE) surface were used. The bondable 2D element under examination was cut to a width of 20 mm and a length of approximately 25 cm, provided with a section for handling, and immediately thereafter pressed onto the respectively selected substrate five times, using a 4 kg steel roller, with an advance speed of 10 m/min. Immediately thereafter, the bondable 2D element was pulled from the substrate at an angle of 180°, using a tensile testing device (from Zwick), and a measurement was made of the force required to achieve this at room temperature. The measurement value (in N/cm) resulted as the average value from three individual measurements.

The shear strength of the bondable 2D element, as a measure of the internal strength of the adhesive, was determined as the holding power in a static shear test. For the measurement, a strip of the bondable 2D element 13 mm wide and 20 mm long was applied to a defined steel test substrate, and pressed on with constant applied pressure four times in longitudinal direction using a 2 kg steel roller, with an advance speed of 30 mm/min. At room temperature, the bondable 2D element was exposed to a constant shearing load, and a measurement was made of the time taken for it to shear from the test substrate: the holding power (in minutes). The respective values for the holding power result as average values from three measurements. The shearing load under standard conditions (that is, at an ambient temperature of 23° C. and a relative humidity of 50%) was 10 N, or 5N for an ambient temperature of 60° C.

The initial tack was determined as follows: the measure used for the initial tack with a very short contact time was the parameter known as rolling ball tack. A strip of the bondable 2D element approximately 30 cm long was affixed horizontally, with the adhesive side upwards, under tension on the test plane. A steel sample ball (diameter: 11 mm; mass: 5.6 g) was cleaned with acetone and conditioned for 30 minutes under standard conditions (temperature: 23° C.±1° C.; relative humidity: 50%±1%). For the measurement, the steel ball was accelerated by rolling down a ramp which was 65 mm high (angle of inclination: 21°) under the earth's gravity. From the ramp, the steel ball was steered directly onto the adhesive surface of the sample. The distance travelled on the adhesive until the ball reached standstill was measured. The rolling distance determined in this way serves as an inverse measure of the initial tack of the self-adhesive composition in the case of a polar rolling body (i.e., the shorter the rolling distance, the greater the initial tack, and vice versa). The respective measurement value resulted (as an indication of length in mm) from the average value for five individual measurements each on five different strips of the bondable 2D element.

Finally, the glass transition temperature of each PSA was determined by means of DSC.

The results obtained in the course of this testing are shown in Table 2.

TABLE 2

| | | | | | | | Glass |
|---|---|---|---|---|---|---|---|
| | | | | Holding power | | Rolling | transition |
| | Bond strength [N/cm] | | | [min] | | ball tack | temperature |
| Sample | Steel/23° C. | PE/23° C. | PE/−10° C. | 23° C. | 60° C. | [mm] | [° C.] |
| E1 | 9.7 | 5.9 | 3.4 | >10 000 | 359 | 23 | −28 |
| E2 | 12.8 | 10.9 | 3.6 | >10 000 | 5623 | 26 | −32 |
| E3 | 9.9 | 6.6 | 7.7 | >10 000 | >10 000 | 15 | −34 |
| E4 | 6.1 | 4.8 | 7.9 | >10 000 | >10 000 | 31 | −33 |
| E5 | 9.9 | 8.0 | 15.7 | >10 000 | 8742 | 38 | −24 |
| C1 | 11.3 | 10.2 | 0.7 | >10 000 | 7430 | 32 | −12 |
| C2 | 7.9 | 5.0 | 1.0 | >10 000 | 5214 | 39 | −17 |

The measurements show that the samples and the comparative examples had an average bond strength at room temperature on steel and polyethylene substrates. At an ambient temperature of −10° C., however, the inventive samples exhibited a significantly higher bond strength on polyethylene than the adhesives of the comparative examples, which were blended with a liquid oil. The bond strengths at low temperatures determined for the adhesives of the invention were greater by a factor of 4 to 10 than the corresponding values for the comparative examples, and in one case even by a factor of more than 22. In this case (sample E5) the adhesive in question was composed of a base polymer mixture (about 40% by weight) and tackifier resins (about 60% by weight), with about 60% by weight of the base polymer mixture being composed of a diblock copolymer with polystyrene blocks and polybutadiene blocks (corresponding to 24% by weight, based on the adhesive), and with about 42% by weight of the tackifier resins being aliphatic tackifier resins that are liquid at room temperature, and the remaining 58% by weight of the tackifier resins being solid alpha-pinene resins (corresponding to about 25% by weight and, respectively, 35% by weight, based on the adhesive). The high bond strength of this sample was attributed to the particularly high fraction of tackifier resins comprising solid and liquid tackifier resins.

At room temperature, all of the samples investigated exhibited a high holding power. As expected, the holding power was much lower for some of the inventive adhesives (E1 and E2) at higher temperatures, since these adhesives were optimized for use at low temperatures and had only a low fraction of liquid tackifier resins in relation to the solid constituents of the tackifier resin. In contrast, the remaining samples, E3, E4 and E5, even at the higher temperatures, exhibited higher holding powers than the adhesives of the comparative examples.

The initial tack with respect to a sample element having a polar surface (a steel ball) was sufficiently good for all of the examples, and even very good in the case of sample E3. For the inventive samples, the glass transition temperatures measured were consistently under −20° C.; in the case of the comparative examples, in contrast, higher glass transition temperatures were found.

Accordingly it is apparent that, through the use of liquid tackifier resins, it is possible to prepare PSAs which even at low temperatures still have a very high bond strength for apolar substrates. This was not observed, in contrast, for the PSAs of the comparative examples, blended correspondingly with oil.

What is claimed is:

1. A pressure-sensitive adhesive comprising tackifier resins, a first block copolymer of the general structure A-B and a second block copolymer which is composed of at least two and not more than eleven connected subunits of the general structure A-B,
A being in each case a polymer block which comprises monomer units from the group of vinyl compounds containing at least one aromatic group,
B in each case a polymer block which comprises monomer units from the group of unsubstituted and substituted 1,3-dienes, and
the first block copolymer being present in a fraction of at least 50% by weight, based on the total mass of the block copolymers in the adhesive,
wherein
at least 30% by weight of the tackifier resins are liquid at room temperature, based on the total mass of the tackifier resins,
the tackifier resins that are liquid at room temperature being tackifier resins which are not homogeneously miscible with the polymer blocks A and also are substantially homogeneously miscible with the polymer blocks B.

2. Pressure-sensitive adhesive according to claim 1, wherein the tackifier resins that are liquid at room temperature are aliphatic tackifier resins.

3. Pressure-sensitive adhesive according to claim 1, wherein the pressure-sensitive adhesive is adjusted for a glass transition temperature of less than −15° C.

4. Pressure-sensitive adhesive according to claim 1, wherein the tackifier resins comprise polyterpene resins and/or pinenes.

5. Pressure-sensitive adhesive according to claim 1, wherein the tackifier resins have a softening point of at least +100° C.

6. Pressure-sensitive adhesive according to claim 1, wherein A is in each case a polymer block which comprises monomer units from the group of unsubstituted and/or substituted styrenes.

7. Pressure-sensitive adhesive according to claim 6, wherein B is in each case a polymer block which comprises monomer units from the group of unsubstituted and/or substituted 1,3-butadienes and/or isoprenes.

8. Pressure-sensitive adhesive according to claim 1, wherein the first block copolymer and/or the second block copolymer contain/s a fraction of at least 20% by weight of monomer units from the group of unsubstituted and/or substituted styrenes.

9. Pressure-sensitive adhesive according to claim 1, wherein the subunits in the second block copolymer are connected to one another linearly or in star format.

10. Pressure-sensitive adhesive according to claim 1, wherein the first block copolymer and the second block copolymer are present together in a fraction of at least 20% by weight and not more than 70% by weight based in each case on the total mass of the adhesive.

11. A method for producing a pressure-sensitive, substantially two-dimensional element comprising processing a pressure-sensitive adhesive according to claim 1 and optionally a carrier into said pressure-sensitive, substantially two-dimensional element.

12. Pressure-sensitive, substantially two-dimensional element comprising a pressure-sensitive adhesive according to claim 1.

13. A method for bonding with a surface having a surface energy of less than 45 mJ/m², said method comprising adhering a pressure-sensitive, substantially two-dimensional element according to claim 12 to said surface having a surface energy of less than 45 mJ/m².
